(19) United States
(12) Patent Application Publication
(10) Pub. No.: US 2026/0167901 A1
(43) Pub. Date: Jun. 18, 2026

(54) CLEANING COMPOSITION AND METHOD FOR REMOVING POLYMER FILM USING THE SAME

(71) Applicant: HONGYUE ADVANCED TECHNOLOGY CO., LTD., Hsinchu City (TW)

(72) Inventor: Ying-Hao Li, Hsinchu City (TW)

(21) Appl. No.: 19/415,874

(22) Filed: Dec. 11, 2025

(30) Foreign Application Priority Data
Dec. 16, 2024 (TW) 113148967

(51) Int. Cl. C11D 7/32; C11D 7/26

(52) U.S. Cl. CPC C11D 7/3209; C11D 7/263; C11D 7/3263; C11D 7/3281; C11D 2111/22; C11D 2111/44

(57) ABSTRACT

The present disclosure relates to a cleaning composition and a method for removing polymer film bonding materials using the same, especially for removing siloxane polymer bonding materials, wherein the cleaning composition at least comprises tetraalkylammonium fluoride (weight percentage concentration: 0.1%-15%), alkyl amide (weight percentage concentration: 20%-95%), aromatic ether (weight percentage concentration: 1%-80%) and water.

### CROSS-REFERENCE TO RELATED APPLICATION

This application claims the benefit of Taiwan Patent Application No. 113148967 filed on Dec. 16, 2024. The entirety of each Application is incorporated herein by reference.

### BACKGROUND

### 1. Technical Field

The present disclosure relates to a cleaning composition and a method for removing residual polymer film by using the cleaning composition, especially to a cleaning composition and a method for removing bonding materials applied in a cleaning process of bonding materials during a packaging process, a power device process, a micro electromechanical process, and a compound wafer process.

### 2. Description of Associated Art

High-speed computation is now essential across various applications such as virtual reality, autonomous vehicles, and artificial intelligence. Consequently, the focus of the semiconductor industry has fundamentally shifted from Moore's Law to heterogeneous integration and advanced high-density packaging. Wafer level packaging (WLP) has been evolved significantly, achieving system level packaging integration. As the chip area shrinks and the demand for increased input/output bandwidth and quantity continuously increases, innovative advanced packaging designs are needed to sustain the requirement for high bandwidth.

In the past, the packaging industry relied on the flip chip process for the majority of WLP applications. In recent years, numerous advanced WLPs have been developed to achieve higher density applications, including various forms of fan-out wafer level packaging, fan-in wafer level chip size packaging, 3D FOWLP, 2.5D integrated intermediate layer technology, and 3D IC integration using silicon via (TSV) interconnects.

Multiple WLP technologies require a carrier to support wafer thinning during manufacturing, and carrier assisted wafer thinning has been proven to be a reliable method. This method uses polymer materials to temporarily bond wafers onto a carrier, controlling the overall stability of the structure during thinning and other processes.

In the temporary bonding process, a polymer bonding material is used to mount the wafer onto a carrier, and the bonding material and the carrier support the wafer during thinning and subsequent crystal back processing. To ensure adequate bonding and separation performances, as well as structural stability during manufacturing, the design of bonding materials should take into account the compatibility of thermal expansion coefficients, the ability to withstand high stresses generated by thermal cycles, and the ease of separation at the end of the process into account.

Temporary bonding technology has been widely applied in large-scale production environments for processing ultra-thin chips through standard wafer fabrication process such as deposition, dry or wet etching, electroplating, and cleaning. Ultra-thin wafers are processed by using the temporary bonding technology, including packaging, power components, microelectromechanical and III-V wafer processes.

In response to the requirement for high performance, low cost and small size of electronic devices, a fan-out wafer-level packaging has been developed as an advanced packaging technique. The temporary bonding/separation technique, on which the advanced fan-out technique relies, constitutes the foundation for manufacturing devices.

Before thinning the wafer, it is necessary to first fix the wafer and bonding material on a carrier made of glass, alumina, silicon wafer, or silicon carbide, temporarily bonding the carrier substrate to the wafer, and then perform subsequent processes to avoid the problem of insufficient strength of the thinned wafer and easy breakage during process handling.

In the manufacturing process of power elements such as insulated gate bipolar transistors (IGBTs) and metal oxide semiconductor field-effect transistors (MOSFETs), the wafer also needs to be thinned to less than 100 μm. In the process of compound wafer manufacturing, common wafer materials include brittle materials such as gallium arsenide, silicon carbide, indium phosphide, gallium nitride, etc. When thinned to below 150 μm, the wafer materials are highly prone to cracking, and some exhibit high residual stress, which can easily lead to warpage, thereby making the carrier support system necessary. To enable the compound wafer to subject high stress and temperature during wafer thinning and downstream processing, a polymer bonding material system is required.

Thin microelectromechanical element wafers are also limited by the same brittleness, and microelectromechanical packaging typically requires high-temperature process steps such as sealing or prolonged exposure to high-energy reactive ion etching. A specially designed polymer bonding material system is required to provide stable temporary bonding under harsh conditions.

Finally, the wafer needs to be separated from the carrier, and mechanical separation and laser separation are commonly used separation methods. Residual bonding materials on the carrier and wafer must be washed out completely, after which the wafer can be subjected to subsequent processes and the carrier can be reused.

In response to the trends of high-temperature processing, wafer thinning, thick film bonding materials, and high stress wafer manufacturing processes, temporary bonding materials need to use siloxane polymer materials, which require low-temperature and simplified bonding/separation procedures to increase production and reduce process costs.

Most commercial cleaning agents for removing silicone polymer materials contain 2-pyrrolidone derivative compounds, such as N-methylpyrrolidone and N-ethylpyrrolidone, which are chemicals known to exhibit reproductive toxicity. The current trend is toward prohibition, restriction or reduction in their use. The cleaning composition developed in the present disclosure can be used for removing residual bonding materials on the carrier and wafer after mechanical and laser separation. The composition is free of 2-pyrrolidone derivative compounds, representing a novel and environmental friendly formulation designed to meet environmental protection requirements and reduce the risk of personnel exposure to reproductive toxicants.

In view of the various shortages and limitations in application of known cleaning compositions, it is in urgent need to develop etched to a cleaning composition and a method for removing polymer film bonding materials by using the cleaning composition.

### SUMMARY

An object of the present disclosure is to provide a cleaning composition capable of effectively removing residual polymer bonding materials on a carrier and a wafer after mechanical separation or laser separation, in particular a cleaning composition for removing siloxane polymer materials.

The present disclosure provides a cleaning composition for removing polymer film bonding materials, and the cleaning composition comprises a quaternary ammonium fluoride salt compound, an alkyl amide compound, an aromatic ether compound, and water.

In an embodiment, based on a total weight of the cleaning composition, the quaternary ammonium fluoride salt compound can have a concentration of 0.1% to 15% by weight, the alkyl amide compound can have a concentration of 20% to 95% by weight, the aromatic ether compound can have a concentration of 1% to 80% by weight, and the balance water.

In an embodiment, based on the total weight of the cleaning composition, the quaternary ammonium fluoride salt compound can have a concentration of 5% to 15% by weight, the alkyl amide compound can have a concentration of 30% to 85% by weight, the aromatic ether compound can have a concentration of 10% to 60% by weight, and the balance water.

In an embodiment, the quaternary ammonium fluoride salt compound can be a compound represented by Formula (I) or Formula (II) or a hydrate thereof:

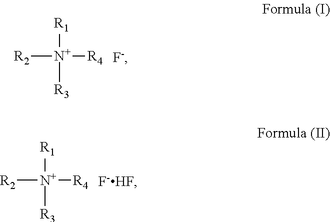

wherein R₁, R₂, R₃, and R₄ are each independently a C₁-C₁₀ alkyl or a C₁-C₁₀ alkyl substituted with a C₆-C₁₂ aryl.

In an embodiment, the quaternary ammonium fluoride salt compound can comprise at least one selected from the group consisting of tetramethylammonium fluoride, tetraethlammonium fluoride, tetrapropylammonium fluoride, tetrabutylammonium fluoride, tetrapentylammonium fluoride, tetrahexylammonium fluoride, tetraheptylammonium fluoride, tetraoctylammonium fluoride, tetranonylammonium fluoride, tetradecylammonium fluoride, tetrabutylammonium difluoride, tetraisopropylammonium fluoride, tetraisobutylammonium fluoride, tetra(t-butyl)ammonium fluoride, tetra(t-pentyl)ammonium fluoride, ethyltrimethylammonium fluoride, diethyldimethylammonium fluoride, propyltrimethylammonium fluoride, butyltrimethylammonium fluoride, and benzyltrimethylammonium fluoride.

In an embodiment, the alkyl amide compound can be a compound represented by Formula (III):

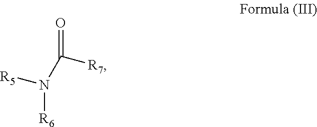

wherein R₅, R₆, and R₇ are each independently H or a C₁-C₄ alkyl.

In an embodiment, the alkyl amide compound comprises at least one selected from the group consisting of N,N-dimethylformamide, N,N-dimethylacetamide, N,N-dimethylpropanamide, N,N-dimethylbutyramide, N,N-dimethylisobutyramide, N,N-diethylformamide, N,N-diethylacetamide, N,N-diethylpropanamide, N,N-diethylbutyramide, N,N-diethylisobutyramide, N,N-dipropylformamide, N,N-dipropylacetamide, N,N-diisopropylformamide, N,N-diisopropylacetamide, N-methylformamide, N-methylacetamide, N-methylpropanamide, N-ethyl-N-methylpropanamide, N-ethyl-N-methylbutyramide, N-ethyl-N-methylisobutyramide, formamide, and acetamide.

In an embodiment, the aromatic ether compound can be a compound represented by R₈—O—R₉, wherein R₈ and R_{y} are independently selected from a C₁-C₄ alkyl, a C₁-C₄ alkyl substituted with a C₆-C₁₂ aromatic group, an unsubstituted C₆-C₁₂ aryl, or a C₆-C₁₂ aromatic group substituted with a C₁-C₄ alkyl.

In an embodiment, the aromatic ether compound can comprise at least one selected from the group consisting of anisole, phenetole, phenyl propyl ether, phenyl butyl ether, phenyl isopropyl ether, dibenzyl ether, diphenyl ether, o-methylanisole, m-methylanisole, p-methylanisole, benzyl ethyl ether, and phenyl benzyl ether.

In an embodiment, the cleaning composition can further comprise an unsubstituted lactam compound.

In an embodiment, the unsubstituted lactam compound can comprise at least one selected from the group consisting of 2-pyrrolidone, 2-piperidinone, and &-caprolactam.

In an embodiment, based on the total weight of the cleaning composition, the unsubstituted lactam compound has a concentration of 1% to 75% by weight.

In an embodiment, the cleaning composition can be free of a 2-pyrrolidone derivative compound, wherein the 2-pyrrolidone derivative compound is a compound in which hydrogen on the nitrogen atom of 2-pyrrolidone is substituted with C₁-C₈ alkyl.

In an embodiment, the 2-pyrrolidone derivative compound can comprise at least one selected from the group consisting of N-methyl-2-pyrrolidone, N-ethyl-2-pyrrolidone, N-n-propyl-2-pyrrolidone, N-isopropyl-2-pyrrolidone, N-n-butyl-2-pyrrolidone, N-isobutyl-2-pyrrolidone, and N-t-butyl-2-pyrrolidone.

In an embodiment, the cleaning composition can be free of a compound having a keto, an ester or a hydroxy group.

The present disclosure further provides a removing method of polymer film bonding materials, comprising: providing the cleaning composition of the present disclosure; heating the cleaning composition; and contacting the cleaning composition with residual polymer film bonding materials on a carrier or wafer to remove the polymer film bonding materials.

In an embodiment, the polymer film bonding materials comprise siloxane polymers.

In an embodiment, the cleaning composition contacts the residual polymer film bonding materials on the carrier or the wafer by soaking, dipping, coating, spin-coating, spraying, or rinsing.

In an embodiment, the cleaning composition is heated at a temperature ranging from 20° C. to 60° C.

In an embodiment, the cleaning composition is heated at a temperature ranging from 20° C. to 40° C.

In an embodiment, the method further comprises, after removing the polymer film bonding materials with the cleaning composition, rinsing the carrier or the wafer with an organic solvent and/or water; and drying the rinsed carrier or wafer with air and/or nitrogen gas.

The cleaning composition of the present disclosure can effectively or completely remove residual siloxane polymer bonding materials on a carrier and wafer after laser separation or mechanical separation. After removing the residual siloxane polymer boding materials on the carrier and wafer, materials on the carrier and wafer would not be corroded. In addition, the cleaning composition of the present disclosure does not include any 2-pyrrolidone derivative compound represents a novel, environment friendly design, meets the requirement for environmental protection, and reduces the risk of workers exposure to reproductively toxic chemical substances. The efficacy of the cleaning composition formulation of the present disclosure cannot be achieved by using an individual component or a combination with other components.

### DETAILED DESCRIPTION OF THE PREFERRED EMBODIMENTS

It should be appreciated that in the present specification, any change of the proportion relationship, or adjustment of the size, without affecting the efficacy and purpose of the present disclosure, should fall in invention scope of the technical content disclosed in the present disclosure. Furthermore, all ranges and values recited in the present disclosure are inclusive and combinable. Any value or point falling in the ranges recited herein, such as any integers, can be used as the lower or upper limit to derive a subrange.

When expressed as “comprise” components or steps herein, other components or other steps can be further included rather than excluded, unless stated otherwise. The term “and/or” is used as an abbreviation for “and” stating a combination of objects and “or” stating alternative objects. The term “or” is used with its meaning including “and/or,” unless indicated otherwise clearly in the context.

The present disclosure provides a cleaning composition comprising a quaternary ammonium fluoride salt compound, an alkyl amide compound, an aromatic ether compound, and water.

The quaternary ammonium fluoride salt compound contained in the cleaning composition of the present disclosure can be a compound represented by Formula (I) or Formula (II):

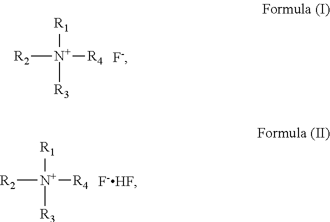

wherein R₁, R₂, R₃, and R₄ are each independently a C₁-C₁₀ alkyl or a C₁-C₁₀ alkyl substituted with a C₆-C₁₂ aryl.

In an embodiment, the quaternary ammonium fluoride salt compound comprises at least one selected from the group consisting of tetramethylammonium fluoride, tetraethlammonium fluoride, tetrapropylammonium fluoride, tetrabutylammonium fluoride, tetrapentylammonium fluoride, tetrahexylammonium fluoride, tetraheptylammonium fluoride, tetraoctylammonium fluoride, tetranonylammonium fluoride, tetradecylammonium fluoride, tetrabutylammonium difluoride, tetraisopropylammonium fluoride, tetraisobutylammonium fluoride, tetra(t-butyl)ammonium fluoride, tetra(t-pentyl)ammonium fluoride, ethyltrimethylammonium fluoride, diethyldimethylammonium fluoride, propyltrimethylammonium fluoride, butyltrimethylammonium fluoride, and benzyltrimethylammonium fluoride.

In an embodiment, the quaternary ammonium fluoride salt compound has a concentration between 0.1% and 15% by weight, based on a total weight of the cleaning composition. Specifically, the quaternary ammonium fluoride salt compound can have a concentration of 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, or 15% by weight, and any between the values described above. In an embodiment, the quaternary ammonium fluoride salt compound has a concentration preferably between 5% to 15% by weight.

Some quaternary ammonium fluoride salt compounds are difficult to be dried and dehydrated into an anhydrous salt due to their high polarity and water solubility, but the quaternary ammonium fluoride salt compound of the present disclosure maintain its efficacy when present in the form of a hydrate, such as tetramethylammonium fluoride tetrahydrate, tetrabutylammonium fluoride trihydrate, etc., but not limited thereto.

The quaternary ammonium fluoride salt compound can clean and remove undesired materials on the surface, for example, dissolving various organic or inorganic materials including particular types of bonding agents and adhesives. The quaternary ammonium fluoride salt compound can remove bonding materials selectively without damaging the integrity of elements, and is suitable for use in precision applications, such as in a semiconductor packaging process. The quaternary ammonium fluoride salt compound can remove polymer bonding materials, particularly a siloxane polymer bonding material, without damaging the underlying substrate or wafer.

A siloxane polymer consists of silicon-oxygen bonds (Si—O), and can be broadly used as bonding and sealing agent due to the excellent thermal resistance, chemical resistance and mechanical performances thereof. Some solvents commonly used cannot decompose the stable Si—O bond due to the high polarity, and thus causes poor solubility of siloxane polymer. As such, a quaternary ammonium fluoride salt compound is employed in the present disclosure as a siloxane-removing agent. A quaternary ammonium fluoride salt compound consists of a tetraalkylammonium cation and a fluoride anion, and the fluoride ion can break the Si—O bonds in the siloxane and in turn decompose a siloxane polymer material into chemical structures having smaller molecules, e.g., siloxane oligopolymers, silanol, or other silicate substances. On the other hand, ammonium cations can promote the dissolution of a solid quaternary ammonium fluoride salt compound in a solvent, e.g., in the alkyl amide compound used herein.

The alkyl amide compounded contained in the cleaning composition of the present disclosure can be the compound of Formula (III):

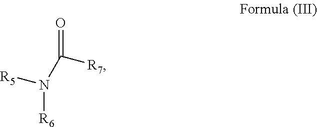

wherein R₅, R₆, and R₇ are each independently H or C₁-C₄ alkyl.

In an embodiment, the alkyl amide compound comprises at least one selected from the group consisting of N,N-dimethylformamide, N,N-dimethylacetamide, N,N-dimethylpropanamide, N,N-dimethylbutyramide, N,N-dimethylisobutyramide, N,N-diethylformamide, N,N-diethylacetamide, N,N-diethylpropanamide, N,N-diethylbutyramide, N,N-diethylisobutyramide, N,N-dipropylformamide, N,N-dipropylacetamide, N,N-diisopropylformamide, N,N-diisopropylacetamide, N-methylformamide, N-methylacetamide, N-methylpropanamide, N-ethyl-N-methylpropanamide, N-ethyl-N-methylbutyramide, N-ethyl-N-methylisobutyramide, formamide, and acetamide.

In an embodiment, the alkyl amide compound has a concentration between 20% to 95% by weight, based on the total weight of the cleaning composition. Specifically, the alkyl amide compound can have a concentration of 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, or 95% by weight, and any one between above values. In an embodiment, the alkyl amide compound has a concentration preferably between 30% to 85% by weight.

A quaternary ammonium fluoride salt compound, usually a solid form at room temperature, is required to be dissolved in a solvent to form a solution which effectively interacts with a siloxane polymer. An alkyl amide compound can dissolve various compounds including polar or non-polar substances, and generally has low toxicity. Therefore, in the present disclosure, the solubility of a quaternary ammonium fluoride salt compound is improved by mixing the alkyl amide compound and the quaternary ammonium fluoride salt compound, to ensure that the quaternary ammonium fluoride salt compound reacts with a siloxane polymer completely.

In addition, the alkyl amide compound can also dissolve a siloxane polymer material having a small molecular structure. In general, the alkyl amide compound has less excellent ability to dissolve a siloxane polymer material, but after the siloxane polymer has been dissolved into the small molecular structure, the ability of the alkyl amide compound of dissolving a siloxane material increases, which enables utilization of highly polar siloxane compound to a certain extent.

The aromatic ether compound contained in the cleaning composition of the present disclosure can be a compound shown by R₈—O—R₉, and R₈ and R₉ are independently selected from C₁-C₄ alkyl, C₁-C₄ alkyl substituted with C₆-C₁₂ aryl, unsubstituted C₆-C₁₂ aryl or C₆-C₁₂ aryl substituted with C₁-C₄ alkyl.

In an embodiment, the aromatic ether compound comprises at least one selected from the group consisting of anisole, phenetole, phenyl propyl ether, phenyl butyl ether, phenyl isopropyl ether, dibenzyl ether, diphenyl ether, o-methylanisole, m-methylanisole, p-methylanisole, benzyl ethyl ether, and phenyl benzyl ether.

In an embodiment, the aromatic ether compound has a concentration between 1% and 80% by weight, based on the total weight of the cleaning composition. Specifically, the alkyl amide compound can have a concentration of 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, or 80% by weight, and any one between above values. In an embodiment, the aromatic ether compound has a concentration preferably between 10% to 60% by weight.

The aromatic ether compound is a compound consisting of aromatic rings bonded with an ether functional group, is weakly polar, and is hydrophobic due to the presence of the aromatic rings, so the aromatic ether compound can dissolve various compound effectively, particularly non-polar and weakly-polar materials. In comparison to aliphatic ethers, an aromatic ether has higher chemical stability and is more suitable for use at an elevated temperature, and the aromatic ring of an aromatic ether compound has a higher Van der Waals' force with a siloxane than an aliphatic ether. Therefore, the present disclosure employs an aromatic ether compound as the component of the cleaning composition.

It has been confirmed by the inventors of the present disclosure through experimentation, compared to that with only alkyl amide compound, the inclusion of the aromatic ether compound in the cleaning composition can further improve the capability for dissolving siloxane polymer materials, both aromatic ether compound and alkyl ether compound can dissolve the siloxane polymer materials having a small molecular structure, increasing the removal efficiency of the cleaning composition for the bonding materials.

In addition to the above components, the cleaning composition includes the balance water. Examples of water which can be used include, for example, ion-exchanged water, reverse osmosis water, distilled water, refined water, purified water, and pure water, etc. can be used, but not limited thereto.

In some embodiments, the cleaning composition of the present disclosure can also comprise a lactam compound, but is free of N-substituted amide compound. Specifically, the cleaning composition of the present disclosure contains no 2-pyrrolidone derivative compound, and more specifically, contains no compound with hydrogen on the nitrogen of 2-pyrrolidone being substituted with a C₁-C₈ alkyl.

In an embodiment, the cleaning composition of the present disclosure can comprise a lactam compound comprising at least one selected from the group consisting of 2-pyrrolidone, 2-piperidinone, and ¿-caprolactam.

In an embodiment, the unsubstituted lactam compound has a concentration between 1% to 75% by weight, based on the total weight of the cleaning composition. Specifically, the alkyl amide compound can have a concentration of 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, or 75% by weight, and any one between above values.

In an embodiment, the cleaning composition of the present disclosure doesn't comprise the 2-pyrrolidone derivative compound selected from the group consisting of N-methyl-2-pyrrolidone, N-ethyl-2-pyrrolidone, N-n-propyl-2-pyrrolidone, N-isopropyl-2-pyrrolidone, N-n-butyl-2-pyrrolidone, N-isobutyl-2-pyrrolidone, and N-t-butyl-2-pyrrolidone.

In comparison to N-substituted lactam compounds, the unsubstituted amide compound, such as the alkyl amide and lactam compound used in the present disclosure, has higher chemical stability, can reduce risk to hydrolysis and degradation of the cleaning composition under various conditions, and allows the composition to have a longer storage or shelf life. More importantly, in comparison to N-substituted lactam compounds, the unsubstituted amide compound has a lower toxicity, a higher safety during handling and use in manufacture or applications, and reduced hazard to human being and environment.

The solvents used, the by-products generated, and vapor generated during production of 2-pyrrolidone derivative compounds are generally toxic, being harmful to health of workers. Also, some 2-pyrrolidone derivative compounds have high tendency to bioaccumulation in organisms, causing a long-term reproductive toxicity. Additionally, 2-pyrrolidone derivative compounds have harmful effects on environment, if the waste liquid has not been properly handled.

Thus, the present disclosure employs an unsubstituted amide compound with lower toxicity and risk to environment instead of the 2-pyrrolidone derivative component commonly used in cleaning compositions. In particular, environment friendly formulations contains the alkyl amide compound having no lactam ring are provided in the present disclosure to meet the requirement for reduced toxic materials ruled in the international laws, achieving the management on hazardous substances and facilitating environmental sustainability while maintaining the performance of the cleaning composition.

Additionally, the present disclosure employs the quaternary ammonium fluoride salt compound to dissolve the siloxane polymer bonding material, and considering the effect of the solvent on fluorides, no compound containing a keto, an ester or a hydroxy group is used in the cleaning composition of the present disclosure. Specifically, in the presence of fluoride ions, an aldol condensation may occur at keto groups to produce a ketene, which can act as a nucleophile to react with or decompose a fluoride, thereby reducing the solubility of the siloxane polymer in the quaternary ammonium fluoride salt compound. On the other hand, an ester may be hydrolyzed in the presence of fluoride ions to form an alcohol and a carboxylic acid, which tends to cause decomposition of the fluorides. Therefore, any compound that is capable of causing such decomposition, and thereby affecting functions of the fluorides due to relative reactions, is not suitable for use as the solvent component in the cleaning composition of the present disclosure.

Without interference with the purpose of the present disclosure, the cleaning composition of the present disclosure also contains other components optionally, e.g., the components commonly used in a cleaning agent, including but not limited to: other solvents, other additives such as corrosion inhibitor, oxidant, cross-linking agent, deterioration inhibitor, interface modifier, surfactant, defoamer, chelating agent, viscosity enhancing agent, dispersing agent, anti-rusting agent, anti-oxidizing agent, anti-bacterial agent, anti-mold agent, polymerization resisting agent, electro-conductivity aid, and the like.

Terms “cleaning,” “removing,” and “separation” used interchangeably herein mean methods for removing, peeling off, washing out bonding materials from a carrier or a wafer by using the cleaning composition of the present disclosure.

The present disclosure further provides a method for removing residual polymer film bonding materials on a carrier or wafer after mechanical separation or laser separation by using the cleaning composition of the present disclosure, especially a method for removing polymer film bonding materials comprising siloxane polymers. The method of the present disclosure comprises: formulating the cleaning composition of the present disclosure to provide the cleaning composition; heating the cleaning composition, and contacting the cleaning composition with residual polymer film bonding materials on the carrier or wafer, to remove the residual polymer film bonding materials on the carrier or wafer after the laser separation or mechanical separation.

Specifically, a quaternary ammonium fluoride salt compound, an alkyl amide compound, an aromatic ether compound, and water (or further an unsubstituted lactam compound) are mixed at a particular ratio to formulate into a cleaning composition. The mixing order has no particular limitation, and the components described above can be mixed simultaneously or in any order, i.e. all components can be mixed collectively; or a portion of the components can be mixed firstly, and then mixed with remaining components further. For example, a quaternary ammonium fluoride salt compound or a hydrate thereof can be firstly dissolved in an alkyl amide compound, and then is mixed with an aromatic ether compound; or alternatively, a quaternary ammonium fluoride salt compound or a hydrate thereof is dissolved in a blended solution of an alkyl amide compound and an aromatic ether compound. Also, the cleaning composition can be filtered with a filter optionally, to remove impurities. In the method of preparing the cleaning composition of the present disclosure, the specific proportion of each component can be set the same as of prefer content of each component in the cleaning composition or the present disclosure described above.

After formulation of the cleaning composition, the cleaning composition is heated to a set temperature. The set temperature can be adjusted depending on kinds and amounts of the components contained in the cleaning composition, and the boiling point of the material used. The set temperature can be between 20° C. to 60° C. Specifically, the set temperature can be 20° C., 25° C., 30° C., 35° C., 40° C., 45° C., 50° C., 55° C., or 60° C., but is not limited thereto. In an embodiment, the set temperature is between 20° C. to 40° C. The heating can be performed with a heat plate, a heater, an oven, or a hot bath, and the like.

After heating the cleaning composition to the set temperature, the cleaning composition is allowed to contact with the surface of the carrier or wafer after laser separation or mechanical separation. The manner for performing the contacting has no particular limitation, and can utilize soaking, dipping, coating, spin coating, spraying, or rinsing method and the like, to contact the cleaning composition with residual polymer film bonding materials, particularly siloxane polymer materials, on the carrier or wafer.

The period for the cleaning composition of the present disclosure contacting the carrier or wafer (e.g., soaking duration) has no particular limitation, as long as the residual bonding materials on the carrier or wafer can be effectively removed, and the carrier or wafer can be removed periodically for observing the cleaning and residue profiles of the siloxane polymer materials. The period for contacting can be 5-70 minutes, e.g., 5 minutes, 5 minutes, 10 minutes, 15 minutes, 20 minutes, 25 minutes, 30 minutes, 35 minutes, 40 minutes, 45 minutes, 50 minutes, 55 minutes, 60 minutes, 65 minutes, or 70 minutes, etc., but is not limited thereto.

In addition to the cleaning step above, the removing method of the present disclosure further comprises, after removing the polymer film bonding materials with the cleaning composition, rinsing the carrier or wafer with an organic solvent and/or water, such as isopropanol, ethanol, propanol, deionized water, etc., to remove the unreacted quaternary ammonium fluoride salt compound and other reaction products, and drying the carrier or wafer with air and/or nitrogen gas.

The carrier and wafer, for which the cleaning composition of the present disclosure is suitable, can be made of a metal oxide (such as an oxide of copper, aluminum, nickel, germanium, zinc, iron, chromium, tin, silver, gold, an alloy thereof, and the like), glass, quartz, silicon carbide, monocrystalline silicon, polycrystalline silicon, silicon dioxide, silicon nitride, silicon carbide, gallium arsenide, gallium nitride, indium phosphide, an organic material, ceramic, prepreg, dielectrics, resin, solder resist materials, etc., but is not limited thereto. The cleaning composition of the present disclosure would not corrode the materials on the carrier and wafer after removing the residual siloxane polymer bonding materials on the carrier and wafer, achieving good cleaning effect without damage to structures of the carrier and wafer.

The polymer film bonding materials of can include various materials, such as polymers, composites, resins, etc., capable of providing adhering capacity. Siloxane polymers like polydimethylsiloxane (PDMS) are suitable for use as semiconductor bonding materials to provide reliable wafer adhering effects at different temperature, due to its flexibility, thermal stability, chemical resistance, and low surface energy. The cleaning composition of the present disclosure is particularly suitable for removing a siloxane polymer bonding material.

The dissolving rate of boding materials is calculated in the thickness removed per minute as: (the bonding material film thickness before soaking (μm)−the bonding material film thickness after soaking (μm))/the duration for soaking in the cleaning composition (minutes)=the dissolving rate of the bonding materials (μm/min). In an embodiment, the bonding material has the dissolving rate greater than 6 μm/min. In an embodiment, the bonding material has the dissolving rate greater than 9 μm/min. In an embodiment, the bonding material has the dissolving rate greater than 12 μm/min. In an embodiment, the bonding material has the dissolving rate greater than 15 μm/min. In an embodiment, the bonding material has the dissolving rate 6 to 15 μm/min.

The execution modes of the present disclosure will be illustrated by following specific embodiments, one skilled in the art can easily realize the advantages and effects of the present disclosure based on the content described in the description, and thus completing the present disclosure. The present disclosure also can be performed or applied by other different execution modes, and the details of the present disclosure each can be imparted with different modifications and alternations based on different views and applications without departing from the scope described by the present disclosure. It should be appreciated that the following examples are provided for illustration of the content of the present disclosure rather than limitation of the scope of the present disclosure.

The preparation of the cleaning compositions in Examples 1-20 and Comparative Examples 1 and 2 were formulated according to the formulations in Table 1 and Table 2. The components in Table 1 and Table 2 were mixed and heated to a set temperature, and the residual siloxane polymer bonding materials (Nissan Chemical Corp., Product No. NAD7009) on the carrier and wafer after mechanical separation or laser separation were washed. The thickness of the bonding material film was measured with a contact film thickness gauge (KLA-Tencor, Product No. P-16+), and the abilities of the cleaning compositions in Examples 1-20 and Comparative Examples 1 and 2 were compared by the dissolving rate data of bonding materials.

The components, set temperature, and dissolving rate of bonding materials of each cleaning composition used in Examples 1-20 were shown in Table 1. The contents of the quaternary ammonium fluoride salt compound, the alkyl amide compound, and the aromatic ether compound shown in Table 1 were expressed as weight percentage concentrations, and the column “Quaternary ammonium fluoride salt compound” were based on weight from which the weight of crystal water had been subtracted to show the actual proportion of the quaternary ammonium fluoride salt compound. Therefore, the sum of percentages of components of the cleaning composition should be 100% tanking water into account. In the Tables, the column “Dissolving rate of boding materials” was calculated through the method described above and expressed in μm/min.

TABLE 1
Examples

| | | Components of cleaning composition (%) | | | |
|---|---|---|---|---|---|
| | | Quaternary ammonium | | Aromatic | Dissolving rate of |
| | Temperature | fluoride salt compound | | ether | boding materials |
| Ex. | (° C.) | (%, free of water) | Alkyl amide compound | compound | (μm/min) |
| 1 | 22 | Tetramethylammonium | N,N-diethylformamide | Phenetole | 10.8 |
| | | fluoride tetrahydrate | 61% | 26.5% | |
| | | 7% | | | |
| 2 | 22 | Tetramethylammonium | N,N-dipropylacetamide | Anisole | 9.9 |
| | | fluoride tetrahydrate | 77.5% | 10% | |
| | | 7% | | | |
| 3 | 22 | Tetramethylammonium | N,N-diethylacetamide | Diphenyl ether | 13.9 |
| | | fluoride tetrahydrate | 33.2% | 49% | |
| | | 10% | | | |
| 4 | 22 | Tetramethylammonium | N,N-dipropylformamide | Anisole | 13.9 |
| | | fluoride tetrahydrate | 41.2% | 41% | |
| | | 10% | | | |
| 5 | 32 | Tetramethylammonium | N,N-diethylpropanamide | Dibenzyl ether | 15.4 |
| | | fluoride tetrahydrate | 64% | 27% | |
| | | 5% | | | |
| 6 | 22 | Tetramethylammonium | N,N-diisopropylformamide | Phenyl | 7.0 |
| | | fluoride tetrahydrate | 31% | isopropyl | |
| | | 5% | | ether | |
| | | | | 60% | |
| 7 | 32 | Tetramethylammonium | N,N-dimethylpropanamide | Anisole | 17.6 |
| | | fluoride tetrahydrate | 46% | 45% | |
| | | 5% | | | |
| 8 | 22 | Tetramethylammonium | N,N-dimethylacetamide | Anisole | 17.3 |
| | | fluoride tetrahydrate | 41.2% | 41% | |
| | | 10% | | | |
| 9 | 22 | Tetramethylammonium | N,N-diethylformamide | Anisole | 7.8 |
| | | fluoride tetrahydrate | 46% | 45% | |
| | | 5% | | | |
| 10 | 22 | Tetramethylammonium | N-methylformamide | Phenyl propyl | 9.7 |
| | | fluoride tetrahydrate | 61% | ether | |
| | | 7% | | 26.5% | |
| 11 | 22 | Tetrabutylammonium | N,N-diethylformamide | Anisole | 15.1 |
| | | fluoride trihydrate | 44% | 44% | |
| | | 10% | | | |
| 12 | 22 | Tetrabutylammonium | N,N-dimethylacetamide | Anisole | 16.8 |
| | | fluoride trihydrate | 62% | 26% | |
| | | 10% | | | |
| 13 | 22 | Tetrabutylammonium | N,N-diethylacetamide | Diphenyl ether | 6.8 |
| | | fluoride trihydrate | 66% | 28% | |
| | | 5% | | | |
| 14 | 22 | Tetrabutylammonium | N,N-dimethylpropanamide | Anisole | 8.4 |
| | | fluoride trihydrate | 47% | 47% | |
| | | 5% | | | |
| 15 | 22 | Tetrabutylammonium | N,N-diethylpropanamide | Diphenyl ether | 10.2 |
| | | fluoride trihydrate | 46.5% | 45% | |
| | | 7% | | | |
| 16 | 22 | Tetrabutylammonium | N-methylformamide | Anisole | 8.2 |
| | | fluoride trihydrate | 31.5% | 60% | |
| | | 7% | | | |
| 17 | 22 | Tetrabutylammonium | N,N-dimethylpropanamide | Anisole | 8.6 |
| | | fluoride trihydrate | 64% | 27.5% | |
| | | 7% | | | |
| 18 | 22 | Tetrabutylammonium | N,N-diethylformamide | Anisole | 11.3 |
| | | fluoride trihydrate | 64% | 27.5% | |
| | | 7% | | | |
| 19 | 22 | Tetrabutylammonium | N,N-diisopropylacetamide | Anisole | 13.6 |
| | | fluoride trihydrate | 44% | 44% | |
| | | 10% | | | |
| 20 | 22 | Tetrabutylammonium | N,N-dimethylacetamide | Anisole | 12.6 |
| | | fluoride trihydrate | 64% | 27.5% | |
| | | 7% | | | |

The components, set temperature, and dissolving rate of bonding materials of each cleaning composition used in Comparative Examples 1 and 2 were shown in Table 2. The weight percentage concentrations in the column “Quaternary ammonium fluoride salt compound” shown in Table 2 were also based on weight from which the weight of crystal water had been subtracted to show the actual proportion of the quaternary ammonium fluoride salt compound, and thus the sum of percentages of components of the cleaning composition was also 100% tanking water into account. The components of the cleaning compositions of Comparative Examples in Table 2 were free of aromatic ether compound.

TABLE 2
Comparative Examples

| | | Components of cleaning | | Dissolving |
|---|---|---|---|---|
| | | composition (%) | | rate of |
| | Temper- | Quaternary ammonium | | boding |
| Comp. | ature | fluoride salt compound | Alkyl amide | materials |
| Ex. | (° C.) | (% free of water) | compound | (μm/min) |
| 1 | 22 | Tetramethyl- | N,N-dimethyl- | 5.7 |
| | | ammonium fluoride | propanamide | |
| | | tetrahydrate | 91% | |
| | | 5% | | |
| 2 | 22 | Tetrabutyl- | N,N- | 5.6 |
| | | ammonium fluoride | dimethyl- | |
| | | trihydrate | acetamide | |
| | | 5% | 94% | |

The Examples in Table 1 confirmed that the cleaning compositions formulated with different concentrations and types of quaternary ammonium fluoride salt compounds, alkyl amide compounds, and aromatic ether compounds could achieve excellent removing effects on bonding materials. In particular, the dissolving rate of bonding materials was further improved when the aromatic ether compound was included in the cleaning composition, as shown in Examples 7 and 12, in which the boding materials had better dissolving rate than those without addition of aromatic ether compound in Comparative Examples 1 and 2.

What is claimed is:

1. A cleaning composition for removing polymer film bonding materials, comprising:
a quaternary ammonium fluoride salt compound;
an alkyl amide compound;
an aromatic ether compound; and
water.

2. The cleaning composition of claim 1, wherein based on a total weight of the cleaning composition, the quaternary ammonium fluoride salt compound has a concentration of 0.1% to 15% by weight, the alkyl amide compound has a concentration of 20% to 95% by weight, the aromatic ether compound has a concentration of 1% to 80% by weight, and the balance water.

3. The cleaning composition of claim 1, wherein based on a total weight of the cleaning composition, the quaternary ammonium fluoride salt compound has a concentration of 5% to 15% by weight, the alkyl amide compound has a concentration of 30% to 85% by weight, the aromatic ether compound has a concentration of 10% to 60% by weight, and the balance water.

4. The cleaning composition of claim 1, wherein the quaternary ammonium fluoride salt compound is a compound represented by Formula (I) or Formula (II) or a hydrate thereof: 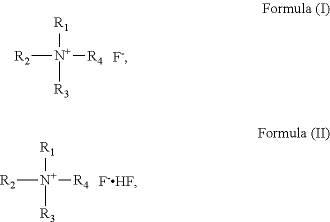
wherein R₁, R₂, R₃, and R₄ are each independently a C₁-C₁₀ alkyl or a C₁-C₁₀ alkyl substituted with a C₆-C₁₂ aryl.

5. The cleaning composition of claim 4, wherein the quaternary ammonium fluoride salt compound comprises at least one selected from the group consisting of tetramethylammonium fluoride, tetraethlammonium fluoride, tetrapropylammonium fluoride, tetrabutylammonium fluoride, tetrapentylammonium fluoride, tetrahexylammonium fluoride, tetraheptylammonium fluoride, tetraoctylammonium fluoride, tetranonylammonium fluoride, tetradecylammonium fluoride, tetranonylammonium difluoride, tetraisopropylammonium fluoride, tetraisobutylammonium fluoride, tetra(t-butyl)ammonium fluoride, tetra(t-pentyl)ammonium fluoride, ethyltrimethylammonium fluoride, diethyldimethylammonium fluoride, propyltrimethylammonium fluoride, butyltrimethylammonium fluoride, and benzyltrimethylammonium fluoride.

6. The cleaning composition of claim 1, wherein the alkyl amide compound is a compound represented by Formula (III): 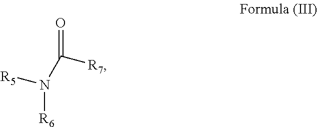
wherein R₅, R₆, and R₇ are each independently H or C₁-C₄ alkyl.

7. The cleaning composition of claim 6, wherein the alkyl amide compound comprises at least one selected from the group consisting of N,N-dimethylformamide, N,N-dimethylacetamide, N,N-dimethylpropanamide, N,N-dimethylbutyramide, N,N-dimethylisobutyramide, N,N-diethylformamide, N,N-diethylacetamide, N,N-diethylpropanamide, N,N-diethylbutyramide, N,N-diethylisobutyramide, N,N-dipropylformamide, N,N-dipropylacetamide, N,N-diisopropylformamide, N,N-diisopropylacetamide, N-methylformamide, N-methylacetamide, N-methylpropanamide, N-ethyl-N-methylpropanamide, N-ethyl-N-methylbutyramide, N-ethyl-N-methylisobutyramide, formamide, and acetamide.

8. The cleaning composition of claim 1, wherein the aromatic ether compound is a compound represented by R₈—O—R₉, wherein R₅ and R₉ are independently selected from a C₁-C₄ alkyl, a C₁-C₄ alkyl substituted with a C₆-C₁₂ aryl, an unsubstituted C₆-C₁₂ aryl or a C₆-C₁₂ aryl substituted with a C₁-C₄ alkyl.

9. The cleaning composition of claim 8, wherein the aromatic ether compound comprises at least one selected from the group consisting of anisole, phenetole, phenyl propyl ether, phenyl butyl ether, phenyl isopropyl ether, dibenzyl ether, diphenyl ether, o-methylanisole, m-methylanisole, p-methylanisole, benzyl ethyl ether, and phenyl benzyl ether.

10. The cleaning composition of claim 1, wherein the cleaning composition further comprises an unsubstituted lactam compound.

11. The cleaning composition of claim 10, wherein the unsubstituted lactam compound comprises at least one selected from the group consisting of 2-pyrrolidone, 2-piperidinone, and s-caprolactam.

12. The cleaning composition of claim 9, wherein based on the total weight of the cleaning composition, the unsubstituted lactam has a concentration of 1% to 75% by weight.

13. The cleaning composition of claim 1, wherein the cleaning composition is free of a 2-pyrrolidone derivative compound, wherein the 2-pyrrolidone derivative compound is a compound in which hydrogen on the nitrogen atom of the 2-pyrrolidone is substituted with a C₁-C₈ alkyl.

14. The cleaning composition of claim 13, wherein the 2-pyrrolidone derivative compound comprises at least one selected from the group consisting of N-methyl-2-pyrrolidone, N-ethyl-2-pyrrolidone, N-n-propyl-2-pyrrolidone, N-isopropyl-2-pyrrolidone, N-n-butyl-2-pyrrolidone, N-isobutyl-2-pyrrolidone, and N-t-butyl-2-pyrrolidone.

15. The cleaning composition of claim 1, wherein the cleaning composition is free of a compound having a keto group, an ester group, or a hydroxy group.

16. A method of removing polymer film bonding materials, comprising:
providing the cleaning composition of claim 1;
heating the cleaning composition; and
contacting the cleaning composition with residual polymer film bonding materials on a carrier or a wafer to remove the polymer film bonding materials.

17. The method of claim 16, wherein the polymer film bonding materials comprise siloxane polymers.

18. The method of claim 16, wherein the cleaning composition contacts the residual polymer film bonding materials on the carrier or the wafer by soaking, dipping, coating, spin-coating, spraying, or rinsing.

19. The method of claim 16, wherein the cleaning composition is heated at a temperature ranging from 20° C. to 60° C.

20. The method of claim 16, further comprising rinsing the carrier or the wafer with an organic solvent and/or water after removing the polymer film bonding materials with the cleaning composition; and drying the rinsed carrier or wafer with air and/or nitrogen gas.
